(19) United States
(12) Patent Application Publication
(10) Pub. No.: US 2010/0106863 A1
(43) Pub. Date: Apr. 29, 2010

(54) INFORMATION PROCESSING APPARATUS, AND CONTROL METHOD OF INFORMATION PROCESSING APPARATUS

(75) Inventor: Akira Kuronuma, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/581,719

(22) Filed: Oct. 19, 2009

(30) Foreign Application Priority Data
Oct. 20, 2008 (JP) 2008-269937 (PAT.

(51) Int. Cl. G06F 3/00

(52) U.S. Cl. 710/12

(57) ABSTRACT

An information processing apparatus includes a first USB communication port connecting with a first device, a communication unit configured to send a command requesting information of the first device to the first device and to receive a response to the command from the first device, a first determination unit configured to determine whether the first device can shift to a suspend status, based on the response received by the communication unit, a second determination unit configured to determine whether there is a command to be sent to the first device other than the sent command, and a control unit configured to set the first USB communication port to the suspend status based on the determination of the first determination unit and the determination of the second determination unit.

### BACKGROUND OF THE INVENTION

1. Field of the Invention

The present invention relates to an information processing apparatus, and a control method of the information processing apparatus.

2. Description of the Related Art

A universal serial bus (USB) interface is known as a interface for connecting a host computer with peripheral devices such as printers. A data transfer between a host computer and a printer is generally performed using a bulk transfer mode. The host computer transfers the data in each packet including a specific plurality of bytes. The printer sends an acknowledgment (ACK) when it successfully receives the transferred packet. The printer sends a negative acknowledgment (NACK) when the printer does not receive the packet for a certain reason. The host computer sends the next data when it has received an ACK, or resends the same data which the printer has failed to receive when the computer receives a NACK. Such control between the host computer and the printer secures the transfer of data.

The host computer requests information of a current printer mode (status) from the printer. The request is named a status response request. When the printer receives the status response request, the printer sends the information of the printer status. The printer executes the status request sequence at an interval of 1 ms. The status request is executed when the host computer is operating, and peripheral devices are configured to respond to the status request.

Apparatuses, e.g., the host computer or the printer, are controlled to lower power consumption. Therefore, the USB interface has a suspend mode (status) for lowering electric power.

Japanese Patent Application Laid-Open No. 11-205412 discusses a technique in which a computer monitors a port of an interface, and turns off an electric power of a buffer configured to input data when the computer detects that the interface is not performing data communication. However, in a case where the aforementioned communication is periodically carried out, a suspend status and a normal operation mode are frequently changed to each other, so that power saving is not efficiently controlled.

In addition, the USB interface of the host computer can also be connected with a mouse and a keyboard. However, ports of the USB interface of the host computer cannot suspend separately. Therefore, at a system level of the host computer and the peripheral devices, power consumption cannot be sufficiently lowered.

### SUMMARY OF THE INVENTION

The present invention is directed to an information processing apparatus which can solve the aforementioned problem.

According to an aspect of the present invention, an information processing apparatus includes a first USB communication port connecting with a first device, a second USB communication port connecting with a second device, a communication unit configured to send a command requesting information of the first device to the first device, and to receive a response to the command from the first device, a first determination unit configured to determine whether the first device can shift to a suspend status based on the response received by the communication unit, a second determination unit configured to determine whether there is a command to be sent to the first device other than the sent command, and a control unit configured to set the first USB communication port to the suspend status while holding the second USB communication port in a communicable mode (status) based on the determination of the first determination unit and the determination of the second determination unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a recording system according to the first exemplary embodiment.

FIG. 2 is a flowchart illustrating an operation for controlling an USB port in a host computer in the first exemplary embodiment.

FIG. 3 is a flowchart illustrating an operation for controlling an USB port in a host computer in the second exemplary embodiment.

FIG. 4 is a perspective view of a printer.

### DESCRIPTION OF THE EMBODIMENTS

Various exemplary embodiments, features, and aspects of the invention will be described in detail below with reference to the drawings.

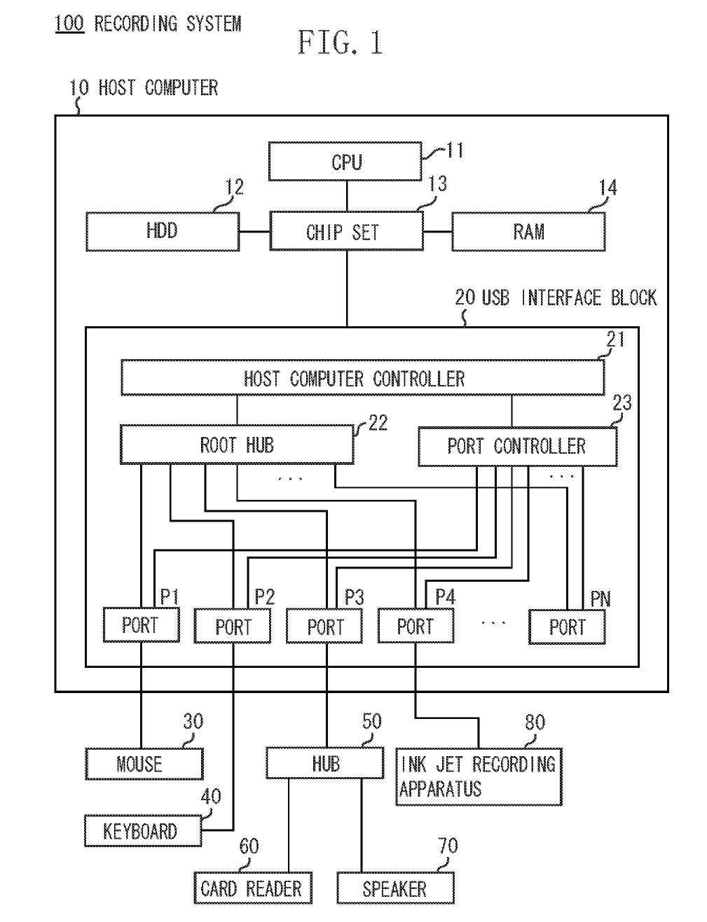

FIG. 1 is a block diagram illustrating a recording system 100 according to the first exemplary embodiment. The recording system 100 is a system for connecting a host computer 10 and a printer 80 via an USB interface. The printer 80 includes a recording head for discharging ink.

The host computer 10 includes a central processing unit (CPU) 11, a hard disk (HDD) 12, a chip set 13, a random access memory (RAM) 14, and an USB interface block 20. The host computer 10 also includes a local area network (LAN) interface, a sound source circuit, and a power source, but their descriptions are omitted herein.

The host computer 10 is connected with the printer 80, a mouse 30, a keyboard 40, and a hub 50, which are peripheral devices, via the USB interface. Further, the host computer 10 is connected with a card reader 60 and a speaker 70 via the hub 50.

The USB interface block 20 includes a host computer controller 21, a root hub 22, a port controller 23, and a plurality of ports (P1 . . . PN). The root hub 22 is a block mainly controlling input/output of data. The port controller 23 mainly performs control concerning a status of the port, such as a normal mode (status) or a suspend mode (status) of the port. For example, when a peripheral device is connected with a certain port, the port controller 23 notifies the connection of the peripheral device to the CPU 11 via the host computer controller 21.

The root hub 22 and the port controller 23 establish channels between the host computer 10 and the peripheral devices in response to a request (command) from the CPU 11. Then, the host computer 10 transfers data to the peripheral devices via the root hub 22.

In the present embodiment, a port P1 connects with the mouse 30, a port P2 connects with the keyboard 40, a port P3 connects with the hub 50, and a port P4 connects with the printer 80.

A recording operation in the inkjet recording system 100 will now be described.

The CPU 11 reads a program stored in the HDD 12 via the chip set 13, and executes the program. The CPU 11 develops image data in the RAM 14, and stores the image data in the HDD 12 one by one.

When the CPU 11 generates image data, the CPU 11 outputs a print order to the printer 80 via the USB interface block 20. Then, the CPU 11 transfers the image data to the printer 80.

The printer 80 prints the image data. When the printer 80 receives a status response request from the host computer 10 while printing the image data, the printer 80 sends a status information indicating that the printer 80 is currently operating to the host computer 10.

When, for example, the printer 80 has no recording medium, the printer 80 sends an error status to the host computer 10 when the printer 80 receives the status response request from the host computer 10. Thus, the printer 80 notifies the host computer 10 that the printer 80 is in an error mode (status).

When the printer 80 recovers from the error status, the printer 80 sends a normal status to the host computer 10. In addition, when the printer 80 completes a printing operation, it sends a status to the host computer 10 indicating that the printer 80 is in a standby mode (status).

When the printer 80 receives the status response request from the host computer 10 while the printer 80 is in a recovery operation of the recording head, the printer 80 sends a busy status to the host computer 10.

More specifically, when the printer 80 does not perform the recording operation, and when the printer 80 does not perform printing processing, the printer 80 notifies the host computer 10 that the printer 80 can shift to the suspend status.

In addition to the recovery operation of the recording head, this processing includes, but is not limited to, a wait process until a temperature of the recording head becomes low, a process for accessing a non-volatile memory provided in the printer 80 (write process or read process), a process for adjusting a printer (registration adjustment), and a process for detecting an remaining ink amount.

When the host computer 10 receives a notification that the printer 80 can shift to the suspend status from the printer 80, and when there is no processing to be performed by the printer 80 in the host computer 10, the host computer 10 performs as follows. The host computer places only the port connecting with the printer 80 in a suspend status. In this case, the host computer 10 places only the port connecting with the recording apparatus in the suspend status, regardless of whether the host computer can shift to the suspend status.

An operation for controlling a USB port in the host computer 10 in the present embodiment is described below.

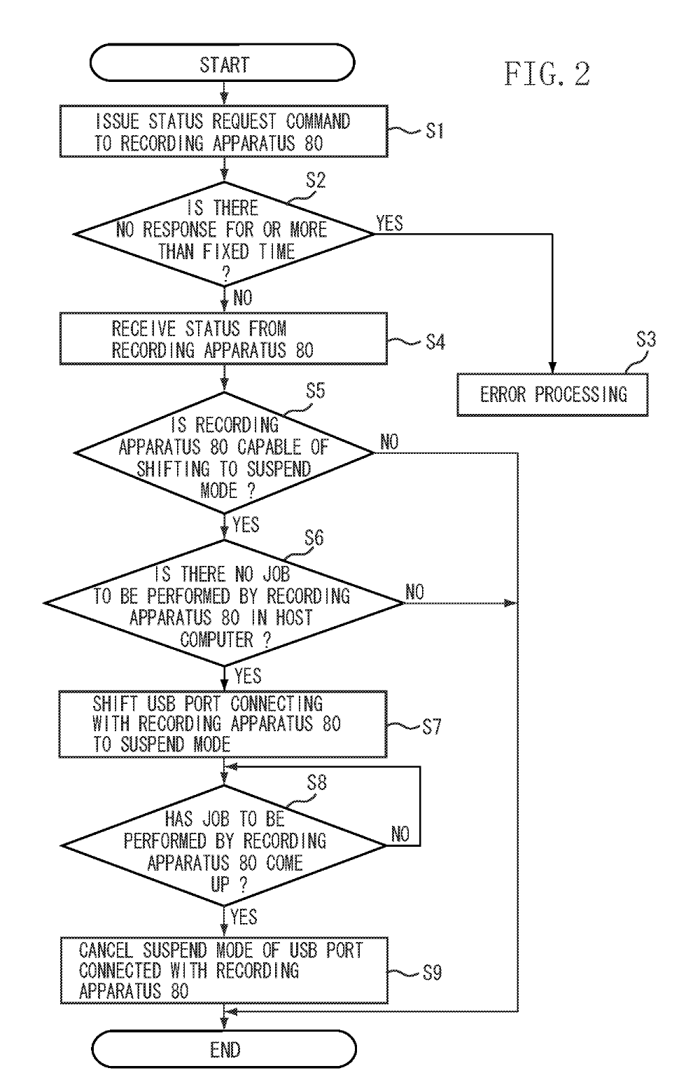

FIG. 2 is a flowchart illustrating control of the host computer 10 in the present embodiment.

In step S1, the host computer 10 issues a status request command to the printer 80, and waits for a response from the printer 80. In step S1, it is assumed that the printer 80 does not receive a command, and can shift to the suspend status.

In step S2, when the host computer 10 determines that there is no status response for a fixed period (YES in step S2), the processing proceeds to step S3. When the host computer 10 determines that there is a status response (NO in step S2), processing proceeds to step S4.

In step S3, the printer 80 determines that the printer 80 is in an error status, and executes error processing. In step S4, the host computer 10 receives the status response from the printer 80, and interprets the status response. In step S5, if the host computer 10 determines that the printer 80 is in a state capable of shifting to the suspend status (YES in step S5), then in step S6, the host computer 10 determines whether there is no job to be performed by the printer 80 in the host computer 10.

When there is no job to be performed by the printer 80 (YES in step S6), processing proceeds to step S7.

In step S7, the host computer 10 sets the port (the port P4 in FIG. 1) connected with the printer 80 to the suspend status via the port controller 23. The USB interface of the printer 80 enters the suspend status by this setting. Therefore, the printer 80 shifts the USB block inside the printer 80 to a power saving mode. Further, the printer 80 shifts to the power saving mode, and shifts a predetermined circuit block to the power saving state. In this power saving mode, the host computer 10 does not issue the status request command to the printer 80. Therefore, the printer 80 holds the power saving mode (power saving mode state).

On the other hand, the host computer 10 issues a status request command every fixed time to other devices connected to the host computer 10.

In step S8, the host computer 10 determines whether a job to be performed by the printer 80 has come up. When the host computer 10 determines that a job to be performed by the printer 80 has come up (YES in step S8), the processing proceeds to step S9. In step S9, the host computer 10 cancels the suspend status of the port P4. Along with the canceling of the suspend status of the port P4, the printer 80 cancels the power saving mode, and waits for the command from the host computer 10.

A second exemplary embodiment of the present invention includes information of a time until the printer 80 cancels the suspend status in the status response. The configuration of the second exemplary embodiment is the same as the configuration of the first exemplary embodiment, so a description thereof is omitted herein.

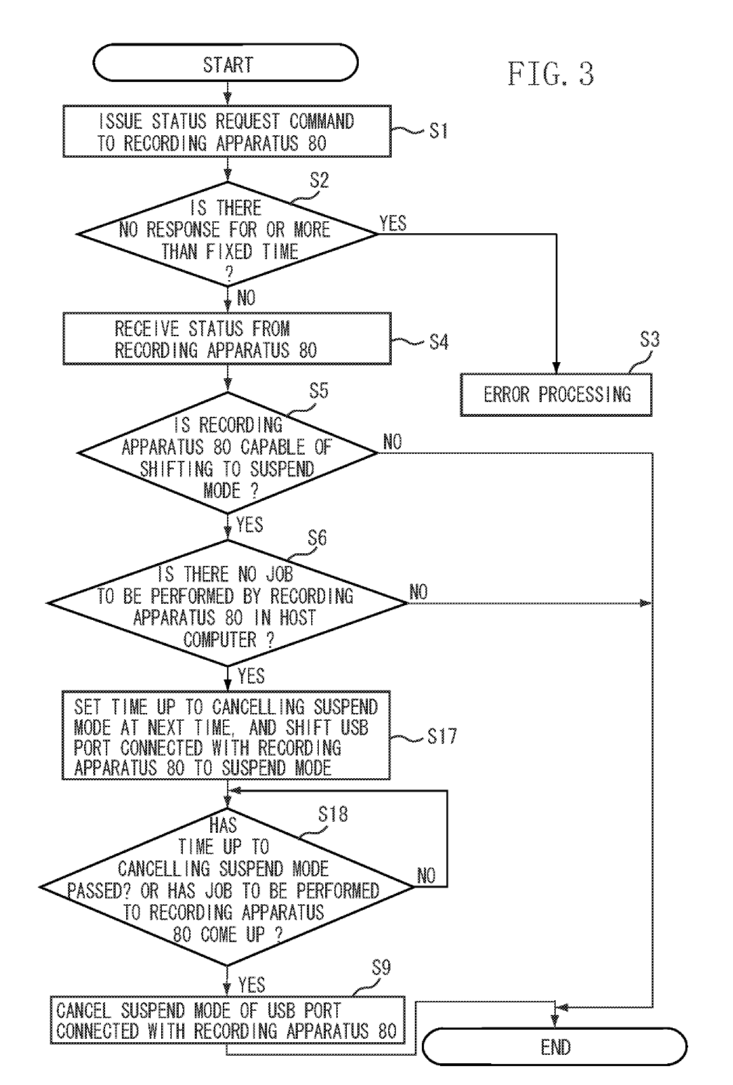

FIG. 3 is a flowchart illustrating control which the host computer 10 performs in the present embodiment. In the following description of FIG. 3, only the contents that differ from the contents in FIG. 2 will be described.

Turning to FIG. 3, steps S17 and S18 are different from the steps of the flowchart in FIG. 2. In step S6, when the host computer 10 determines that there is no job to be performed by the printer 80, in step S17, the host computer 10 sets a time until the printer 80 cancels the suspend mode (status). The time until the printer 80 cancels the suspend mode (status) is set based on information sent from the printer 80.

Therefore, the USB interface block 20 includes a register holding a period of the suspend status, and a timer measuring an elapsed time. The register holding the period of the suspend status is provided to every port. In the present embodiment, the time is set at a register corresponding to the port P4 connecting with the printer 80.

The host computer 10 sets the port (the port P4 in FIG. 1) connecting with the printer 80 to the suspend status. When the host computer 10 sets the port to the suspend status, the host computer 10 starts counting the set time using the timer provided at the USB interface block 20.

In step S18, the host computer 10 determines whether the time until canceling the suspend status elapses or whether the job has come up. When the setting time elapses or a job has come up in step S18 (YES in step S18), processing proceeds to step S9. In step S9, the host computer 10 cancels the suspend status of the port P4.

When the host computer 10 connects with a plurality of printers 80, the host computer 10 sets the time to every port connecting with the printers, and independently controls the start and the cancel of the suspend status.

Accordingly, in the present embodiment, the recording system 100 has a configuration which can set the period of the suspend status. Even when the job to be performed by the printer 80 has not come up, the host computer 10 can cancel the suspend status of the port of the USB interface block 20.

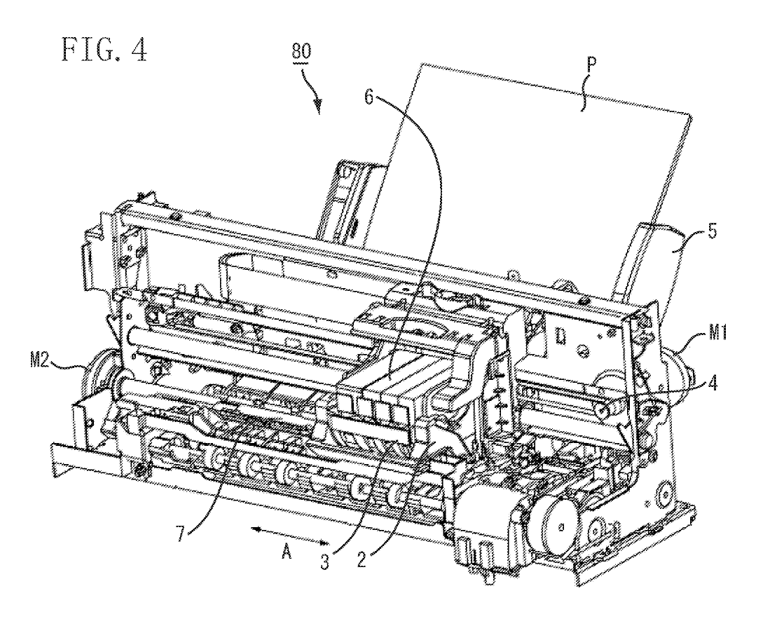

FIG. 4 is a appearance perspective view illustrating a configuration of the printer 80 in the above-described exemplary embodiments. The printer 80 transmits driving force generated by a carriage motor M1 via a transmission mechanism 4 to a carriage 2 mounted with a recording head 3, and causes the carriage 2 to reciprocate in the direction of an arrow A. Contact faces of the carriage 2 and the recording head are properly contacted with each other, and can achieve and hold a required electrical connection. The printer 80 performs recording by feeding a recording medium P via a sheet feeding mechanism 5 driven by a feeding motor M2, conveying the recording medium P to a recording position, and discharging an ink from the recording head 3 to the recording medium P at the recording position. A conveying roller 7 conveys the recording medium P, and is driven by the feeding motor M2.

The carriage 2 of the recording apparatus 1 is mounted with the recording head 3 as well as being equipped with an ink cartridge 6 storing the ink supplying to the recording head 3. The ink cartridge 6 is detachably mounted on the carriage 2.

The carriage 2 carries four ink cartridges accommodating inks of magenta (M), cyan (C), yellow (Y), and black (K). The four ink cartridges are independently and detachably mounted on the carriage 2.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-269937 filed Oct. 20, 2008, which is hereby incorporated by reference herein in its entirety.

What is claimed is:

1. An information processing apparatus comprising:
a first USB communication port connecting with a first device;
a communication unit configured to send a command requesting information of the first device to the first device and to receive a response to the command from the first device;
a first determination unit configured to determine whether the first device can shift to a suspend status based on the response received by the communication unit;
a second determination unit configured to determine whether there is a command to be sent to the first device other than the sent command; and
a control unit configured to set the first USB communication port to the suspend status based on the determination of the first determination unit and the determination of the second determination unit.

2. The information processing apparatus according to claim 1, further comprising:
a second USB communication port connecting with a second device,
wherein the control unit sets the first USB communication port to the suspend status while holding the second USB communication port in a communicable status.

3. The information processing apparatus according to claim 1, wherein the response includes time information about a period of the suspend status, and
wherein the control unit sets the first USB communication port to the suspend status based on the time information.

4. The information processing apparatus according to claim 1, wherein the first device is a printer, and
wherein the second device is an input device configured to operate the information processing apparatus.

5. A method for controlling an information processing apparatus comprising a first USB communication port connecting with a first device and a second USB communication port connecting with a second device, the method comprising:
sending a command requesting information of the first device to the first device;
receiving a response to the command from the first device;
determining whether the first device can shift to a suspend status based on the received response;
determining whether there is a command to be sent to the first device other than the sent command; and
setting the first USB communication port to the suspend status while holding the second USB port in an communicable status based on the determination whether the first device can shift to a suspend status and on the determination whether there is a command to be sent to the first device other than the send command.
